(19) United States
(12) Patent Application Publication
(10) Pub. No.: US 2003/0199319 A1
(43) Pub. Date: Oct. 23, 2003

(54) Method and system for enhanced role playing and computer-user interaction

(76) Inventor: Daniel Culbert, Sunnyvale, CA (US)

Correspondence Address: Daniel Culbert, 1035 Aster Ave #2196, Sunnyvale, CA, 94086, US

(21) Appl. No.: 10/127,796

(22) Filed: Apr. 23, 2002

(51) Int. Cl. A63F 13/00

(52) U.S. Cl. 463/42

(57) ABSTRACT

This is a method for enhanced role-playing, involvement, and simulation control for players in a single or multi-player game, or simulation application.

### TECHNICAL FIELD

This invention relates to computer assisted games, multi-player gaming environments, simulations, the Internet, and more particularly to single player and multi-player fully-networked role playing games and simulations.

### BACKGROUND ART

With the advancement in internet connectivity, the reduction in cost of computational power, and vast improvements in 3D rendering, multi-player games—or a multi-player option for particular games—have become commonplace.

Several companies have published successful multi-player games over the Internet. Of particular interest is the role-playing class of single and multi-player games. These include EverQuest created by Sony Online Entertainment/Verant, and Asheron's call published by Microsoft. The fundamental game rules of these two games are inspired by traditional pen and paper role-playing games, but they have been modified to run across multiple client machines and servers on a computer network. Unfortunately, although these games are classified as role-playing games, very little role-playing actually takes place due to game limitations. The fundamental game engine is tuned for fighting monsters from which user gain experience and subsequently character advancement, and collecting items from successfully killed opponents, and on occasion from a limited form of role-playing call a quest. Users subsequently focus on these game fundamentals—character advancement and collecting items—in lieu of role-playing.

Since this character advancement and item collection are crucial to the longevity of these role-playing games, all players are given a small, finite number of characters that they can play, and in most cases the players play one character only. In the server account setup of these games, the server or servers contains N character profiles, and upon login, a given player k, and only player k, has exclusive access to L character profiles, Pk,1, Pk,2. . . Pk,L where L<<N. Typically L =1. This limits flexibility in computer-user interaction.

Games and commercial applications centered on various forms of simulation have also benefited from these advancements in technology. One example is SIMCITY 2000.™., manufactured by Maxis Inc. of Walnut Creek, Calif., USA, which enables the player to create a world and then simulate how that world will function. The Sims, also from Maxis, is a similar game, but the focus of world creation is limited to a neighborhood only—the game player manipulates and watches the results of individuals performing ordinary everyday tasks which are simulated and run by the computer. These simulation games are very popular, but are currently limited in that the user has no direct control over any one individual. There is no direct role-playing or ultimate goal, so the game focus and enjoyment is limited to the simulation itself. There is no first person involvement.

This invention pertains to provisional application No. 60/287,683.

### SUMMARY OF THE INVENTION

This is a method for enhanced role-playing, involvement, and longevity for players in a single or multi-player game, and collaborative simulation control by many users. The system includes a simulation environment, that is, one or more computers dictate the behavior of one or more characters in the game, and a mechanism by which all players have access to all characters in the game, and are incentivised to role play. During its life, any one character in the game can be controlled by multiple players or the computer.

### BRIEF DESCRIPTION OF THE DRAWINGS

FIG. 1A. is a diagram of a single computer-based game or virtual environment.

FIG. 1B is a diagram of a multi-user game environment and many forms of a typical multi-user networked application.

FIG. 2 is a diagram of the process by which a player b enters and leaves the gaming environment under a given character or object profile.

FIG. 3 is a diagram of how control of a particular character or object is transferred from player to computer and back.

### DETAILED DESCRIPTION

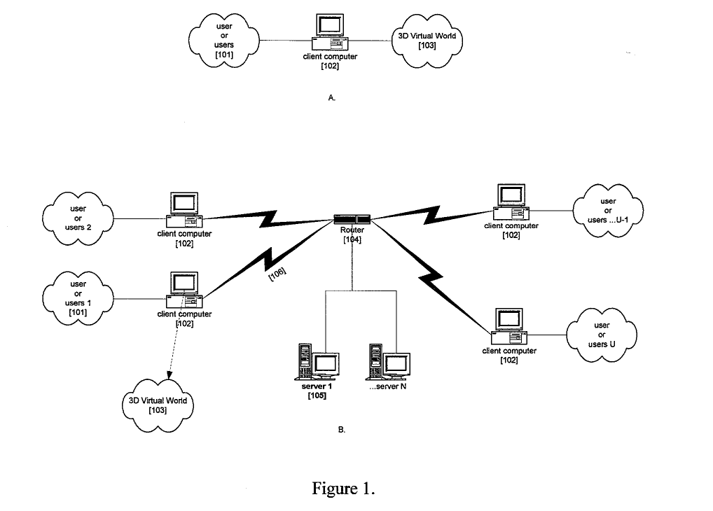

A traditional computer game setup is shown in FIG. 1a. One or more users or players [101] interact with a computer [102] which displays and responds with a particular environment, state, or 3D virtual world [103], typically displayed on a computer monitor, or alternatively on a stereoscopic device, or projection screen. A networked computer game setup is shown in FIG. 1b. Here, one or more users [101] interact with a computer [102]. This computer then communicates via one or more forms of a communication link or network [106] to one or more routers [104] which in turn communicate with a group of servers [105]. These networks are implemented using several forms of physical devices and protocols, including modems and copper wire, twisted pair, and fiber-optic cable. More than one of these client connections may exist, as shown. These servers [105] monitor, control, and synchronize the environment that the users see, with assistance from the client computers [102]. In a smaller network setup, the servers' function [105] may in fact be implemented on a client machine [102]. This setup represents a networked multi-user game, as well as many other multi-user applications. This invention runs on any form of these systems, the preferred form being a networked multi-user system.

A key aspect for several variations of this invention is the ability for either a user or the computer to play any character represented in the game. A player's representation and control in the game is not limited to a small, finite number of avatars or characters. Control over these characters is also unrestricted in that other players or the computer can also play that same character. A character in the game can be any object that is controllable by a player—this includes 3D representations of people, animals, cars, or any other object that has properties that can be controlled in any way during a live game.

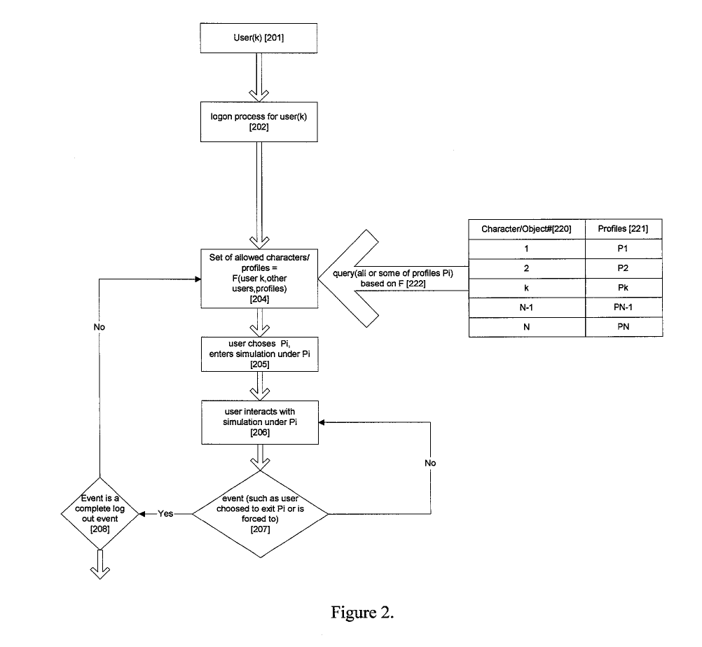

The process by which a player obtains control of a character in the game is shown in FIG. 2. The user [201] first logs into the game [202]. In a multi-player networked game, this login process establishes which user is at the client machine requesting connection, and possibly what personal resources they are entitled to. In a single-player game, this process might be loading a saved game from disk. The user is then presented a set of characters they can choose from, and under what type of conditions they can control that character [204]. This set is a function of the particular user and their personal resources, other users currently on the system, and the profiles of each character in the game. Character information is provided by a table [220,221] which can be stored in a database, file, or in memory. This user then chooses a character and corresponding profile P(i) [205] which describes the properties of the character or controllable object in question, and enters the simulation or gaming environment with full or partial control over the character P(i) [206]. Once in the simulation, specific events [207] can occur which take the user back to stage [204] where they choose an alternate character. These events include but are not limited to: user chooses to abandon control or leave character P(i), other players force user to abandon control of character P(i), gaming rules, or other characters controlled by computer force the user to abandon control of character P(i).

In one variation of this invention, gaming events [207] may not require the user to abandon control of character P(i)—they can choose an additional profile P(m), and control character P(i) and P(m) at the same time. They may repeat this process to control one or more characters simultaneously within the simulation.

In one variation of this invention, the environment under which the characters interact operates is real-time, that is, when a player logs into a particular character, that player may or may not have full control over that character, but when the player logs out, the character does not disappear. Instead, each and every character continues to interact/function under the game or simulation rules and under computer direction. The player has the option to log back in under the same or perhaps a different character.

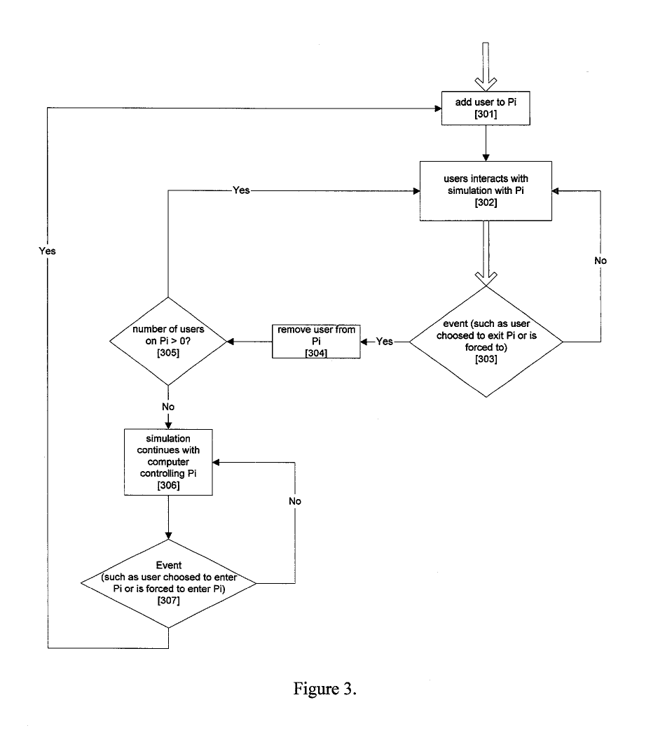

This process is shown in FIG. 3. The user enters the simulation environment and obtains full or partial control of character P(i) [301,302]. If an event occurs that causes this user to lose this control [303], and there are no more players with control remaining on this character [304], the simulation continues uninterrupted with this particular character under full control of the computer [306]. When an event occurs that brings a user back into control of a particular character [307,301]—e.g. a user logged in again or a user is forced to switch from one character to another—the simulation gives the appropriate character and control back to the user [302] without application interruption. In the preferred embodiment of this invention, the simulation is a 3D gaming environment, but many other forms of applications can benefit from this process, e.g. a distributed search process where some of the controllable objects of the search are run by computer, others by users, with the transfer of control from computer to user being integrated into the distributed search process. Another example is simulated annealing or other forms of local or global optimization.

In another variation of this invention, the player's incentive to role-play is enforced by forcing the player to act the role of the particular character they logged into. If the player is successful, they are rewarded. If they are not successful, via an in-game mechanism—that is, a mechanism that fits the plot line or scheme of the game—the player is forced out of that character.

In another variation of this invention, a player must accumulate the equivalent of points to log into and control popular and more powerful characters or objects. The more popular and powerful a character is, the more points required. If a player role-plays successfully, they acquire points. If they do not, they lose points. Points can also be acquired from other traditional gaming rules, including winning particular combat scenarios, performing specific tasks as collecting items, or talking to specific characters.

In another variation, players can cooperate by pooling their points or giving their points to another player. This allows them the option of simultaneous control over a character. In the preferred embodiment of this invention, if multiple users have access to a character, the characters actions are a weighted sum of the controls requested via the players. For movement, the result is a simple average where each player's directional control is weighted by their influence over that character. In the case of speech, the result is the majority score out of a weighted sum of the words typed in or spoken by each user.

In another variation, players can be given the ability to obtain points by spotting other players, that is, spotting which characters are player controlled vs. those that are computer controlled.

In another variation, players are awarded points by grouping with other players and killing certain computer controlled characters or objects in the game whose purpose is to detect players. In this case, the computer attempts to spot which characters are controlled by players.

1. A method of accessing a computer system application comprising:
a. a global table of character profiles;
b. a plurality of users;
c. a login process whereby each of said users has access to said table and their selection of character profiles is a function of user personal account resources, the current state of other users, and the profiles in the table;
d. a level of control over characters selected for each user within the application;

2. The method of claim 1 with the further steps comprising:
a. in-application events which allow said users to modify their control over the characters without application interruption.

3. The method of claim 2 wherein modifying control over characters comprises the steps of:
a. full release of currently controlled character;
b. a process by which user reselects from table of character profiles and reenters application environment.

4. The method of claim 2 wherein modifying control over characters comprises the steps of:
a. partial release of currently controlled character;
b. a process by which a user reselects from table of character profiles and adds a new character profile to a live list of characters said user can control.

5. A method of a computer system simulation comprising:
a. a global table of character profiles;
b. a plurality of users which at any given time within the simulation control a portion of said characters;
c. the remainder of said characters controlled by computer simulation;
d. a user login and logout process whereby a user selects a character from said table of character profiles, and if said character is currently controlled by computer, control is transferred to said user upon login and back to the computer upon user logout, without simulation interruption;
e. internal simulation events which force the transfer of control from user to computer and back during the life of the simulation without simulation environment interruption.

6. A method of claim 5 whereby a user incentive to select and control a character is enforced by the collection of individual resources from mimicking the computer driven behavior of a particular character once they have control.

7. A method of claim 5 where a user must collect a specific amount of individual resources in order to control certain characters in the character profile table.

8. A method of claim 7 in which users may pool their resources in order to control a particular character.

9. A method of claim 6 where a user may also collect individual resources by recognizing whether a user or the computer is currently controlling a character.
